(19) United States
(12) Patent Application Publication
(10) Pub. No.: US 2025/0146547 A1
(43) Pub. Date: May 8, 2025

(54) Disc Brake for a Utility Vehicle, and Brake Lining for a Disc Brake

(71) Applicant: KNORR-BREMSE Systeme fuer Nutzfahrzeuge GmbH, Muenchen (DE)

(72) Inventors: Stefan HUBER, Aldersbach (DE); Josef SCHROPP, Eichendorf (DE); Martin PLEINTINGER, Eichendorf (DE); Natalie ROTH, Aunkirchen (DE); Alexander KOLLER, Fuerstenzell (DE); Thomas STEINHUBER, Ortenburg (DE)

(21) Appl. No.: 18/684,232

(22) PCT Filed: Aug. 8, 2022
(86) PCT No.: PCT/EP2022/072264

§ 371 Date: Feb. 16, 2024

(30) Foreign Application Priority Data
Aug. 20, 2021 (DE) 10 2021 121 683.4

(51) Int. Cl. F16D 65/097; B60T 1/06; F16D 55/00; F16D 55/226; F16D 65/00; F16D 127/02

(52) U.S. Cl. CPC F16D 65/0972; B60T 1/065; F16D 55/226; F16D 65/0056; F16D 2055/0008; F16D 2055/0041; F16D 2127/02

(57) ABSTRACT

A disc brake for a utility vehicle includes a brake caliper that is in the form of a sliding caliper and overlaps a brake disc; two brake pads which are located in the brake caliper, can be moved in opposite directions in the direction of the brake disc, each have a pad backing plate and a friction lining fastened thereto, and are each located in a pad shaft of a vehicle-side brake carrier, which pad shaft is delimited in the direction of rotation of the brake disc by brake carrier horns; and at least one restoring device by which the brake pads can be restored after a braking-related movement and release of the brake. The restoring device has at least one restoring element which is attached to a brake pad, is located between the brake pad and a stationary component, and exerts a restoring force on the brake pad, the at least one restoring element being in the form of a leaf spring which is fastened on the rear side of the pad backing plate facing away from the friction lining and has a spring arm which extends in the peripheral direction of the brake disc and is supported against the brake carrier as a stationary component.

### BACKGROUND AND SUMMARY

The invention relates to a disc brake for a utility vehicle and to a brake pad for a disc brake.

In the case of a disc brake of the generic type, also known as a sliding caliper brake, an action-side brake pad is pressed against a vehicle-side brake disc in the event of braking by means of a clamping device which can be actuated pneumatically or by an electric motor.

In the further course of the braking process, the brake caliper is displaced in relation to the brake disc in the opposite direction to the direction in which the action-side brake pad is applied, taking the opposite-lying, reaction-side brake pad with it and pressing it against the other side of the brake disc.

After the brake is released, the brake caliper remains in this position, in which the brake pads, or at least the reaction-side brake pad, are in contact with the brake disc without pressure, but in a grinding manner. The resulting residual grinding torques of the brake pads during the driving operation have a detrimental effect in that they lead to increased fuel consumption as well as to a reduction in the service life of the brake disc and the brake pads.

It is true that the brake pads loosen slightly during the driving operation, for example as a result of the brake disc wobbling and vibrations and lateral acceleration when cornering. However, these effects are not sufficient to effectively prevent the aforementioned residual grinding torques.

To counter this problem, DE 10 2007 001 213 discloses a disc brake which has a resetting device and is arranged in one of the guide rails via which the brake caliper is displaceably held on the brake carrier and which has a spring resetting element by means of which the brake caliper is displaced into an initial position.

In principle, this design has proven itself. However, the use of this known resetting device can lead to problems in the case of air-operated disc brakes on heavy utility vehicles, since there are wide limits of variable influences due to component tolerances and component deformations, which do not always allow this resetting device to function safely.

Comparable problems arise in the case of a disc brake, as discussed in DE 10 2012 006 111 A1. Here, a resetting device is arranged on the side that lies opposite the clamping device and faces the reaction-side brake pad, whereby an effective, in particular automatic resetting of the brake caliper is achieved with simultaneous minimal intervention in the system rigidity.

In any case, the resetting device acts on the brake caliper, wherein the brake carrier acts as an abutment.

From the generic DE 10 2016 117 777 A1, a disc brake is known in which the resetting device has at least one resetting element that is attached to a brake pad and is arranged between this brake pad and a fixed component, such as a brake carrier, and exerts a resetting force on the brake pad.

Increasingly, disc brakes are being used that are configured in such a way that due to the installation space the resetting device can only correspond to the action-side brake carrier horns at the expense of caliper rigidity. It is also not possible to connect the resetting device to the brake carrier horns that are associated with the reaction-side brake pad, since a pad retaining spring slides on the brake carrier horns. It is therefore not possible to use the known resetting devices in the case of these disc brakes.

The invention is based on the object of further developing a disc brake of the generic type in such a way that the service life, in particular of the brake pads and the brake discs, is increased and the overall operating costs are reduced using the simplest design means.

This object is achieved by a disc brake having the features of the independent claims.

Compared to a disc brake according to the prior art, the design according to the invention offers considerable advantages. These result, among other things, from the extremely simple realization of the invention, since the resetting element that is designed as a leaf spring can be manufactured from a simple spring plate, for example by punching and/or bending, wherein the leaf spring can be attached to the rear side of the pad carrier plate by suitable measures and said rear side faces away from the friction lining of the brake pad. This includes, for example, riveting, screwing, welding, clinching, pressing or the like.

Preferably, a leaf spring is provided on both sides of the brake pad and said leaf spring is supported on the respective associated brake carrier horn, wherein the respective leaf spring projects beyond the brake pad on both of its narrow sides.

The respective projecting end of the leaf spring is braced against the brake carrier in an axial direction so that the resulting spring force exerts a resetting force on the respective brake pad.

By supporting the leaf springs, which are preferably attached to both brake pads, on fixed brake carriers, not only are the brake pads positioned in relation to the brake disc, but also the axially displaceable brake caliper. By centering the brake pads and the brake caliper in relation to the brake disc, an ideal reduction of residual grinding torques can be achieved.

The invention results in a pull-through protection in an advantageous manner, which contributes to the overall functional reliability of the disc brake. The leaf springs that are attached to the rear of the pad carrier plate form a kind of interference contour that effectively prevents component loss of the brake pads.

By supporting the leaf springs on the fixed brake carrier, not only are the brake pads positioned in relation to the brake disc, but also the axially displaceable clamping unit, wherein the centering of the brake pads and the clamping unit in relation to the brake disc achieves a remarkable reduction in residual grinding torques.

The interface between the leaf springs and the brake carrier is designed in such a way that the leaf spring is automatically pre-tensioned when the brake pads are mounted. This means that a resetting force is already applied to the respective brake pad when the brake is new, wherein this pre-tensioning can be achieved by forming a bevel on the brake carrier horns, said bevel rising in the direction of insertion of the brake pad. This is particularly advantageous in that in many cases such a contour is already present as standard as a molded bevel of the cast iron brake carrier.

Additionally or alternatively, a recess can be provided in the brake carrier horns, into which the free end of the spring arm of the leaf spring engages when the brake pad is pushed into the brake carrier, thereby exerting an additional radial retaining force on the brake pad and preventing it from unscrewing when the brake is applied. As a result, this leads to a reduction in wear. Furthermore, the engagement of the leaf spring in the recess can be detected both acoustically and haptically, which indicates that the brake pad has been mounted correctly.

In addition to the resetting of the brake pad, a decisive advantage of the design according to the invention is that the opposite-lying leaf springs are mounted symmetrically in the center of the brake pad, so that no additional tilting moment is exerted on the brake pad.

In the case of an arrangement in which two leaf springs are attached to the opposite-lying narrow sides of the brake pad, the leaf springs can be designed with different spring rates in each case. The resulting uneven spring forces counteract tangential diagonal wear of the brake pad, which occurs more frequently in the case of a disc brake that only has a central brake plunger.

In addition, the axial pre-tensioning of the brake pad by the leaf springs reduces the overall noise and vibration development of the disc brake during the driving operation.

Further advantageous embodiments of the invention are characterized in the dependent claims.

A disc brake according to the prior art and an exemplary embodiment of the invention are described below with reference to the accompanying drawings.

### BRIEF DESCRIPTION OF THE DRAWINGS

FIG. 1 is a plan view of a disc brake according to the prior art;

FIGS. 2-5 each show a perspective view of an exemplary embodiment of the invention.

### DETAILED DESCRIPTION OF THE DRAWINGS

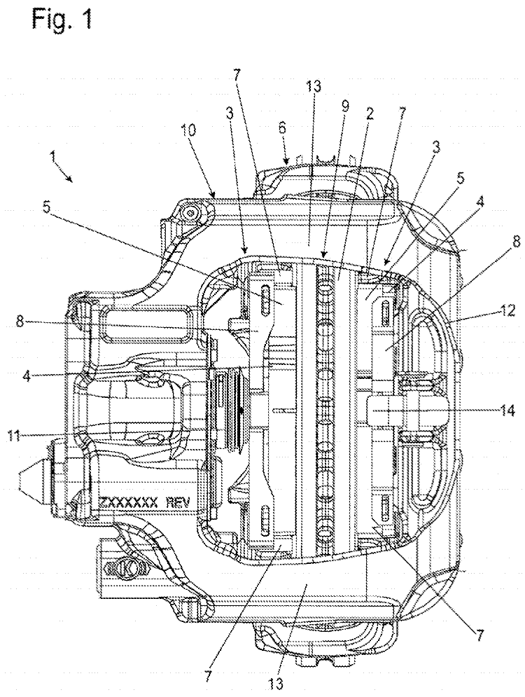

FIG. 1 shows a disc brake 1 according to the prior art, which can be actuated pneumatically, hydraulically, electrically or in combination thereof.

The disc brake 1 has a vehicle-side brake disc 2, against which brake pads 3 are pressed on both sides in the event of braking and said brake pads are held axially displaceable in a fixed brake carrier 6. A brake caliper 10 spans the brake disc 2, wherein the brake caliper 10 is also displaceably attached to the brake carrier 6 and also has a mounting opening 9 through which the brake pads 3 can be inserted into the brake carrier 6.

Opposite a caliper back 12 of the brake caliper 10, a clamping device (not shown) is arranged in a receiving space, by means of which the clamping-side associated brake pad 3 can be pressed against the brake disc 2 via a connected brake plunger 11.

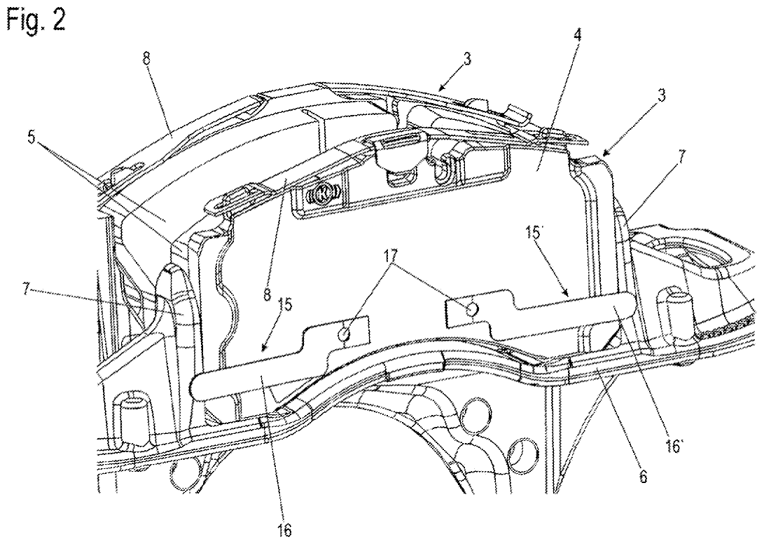

Each brake pad 3 has a pad carrier plate 4 made of cast iron, preferably ductile iron, to which a friction lining 5 is attached on the side that is facing the brake disc 2, wherein the pad carrier plate 4 has two opposite-lying longitudinal sides and two opposite-lying narrow sides in the plan view, as can be seen particularly clearly in FIG. 2. In the event of braking, a pressure piece of the brake plunger 11 is in contact with the clamping-side pad carrier plate 4.

The caliper back 12 is connected to the caliper head, which accommodates the receiving space for the clamping device, via tie rods 13, which laterally delimit the mounting opening 9.

The brake pads 3 are each positioned in a pad shaft between two brake carrier horns 7 of the brake carrier 6.

In order to secure the brake pads 3, pad retaining springs 8 are attached to the side of the pad carrier plate 4 that is facing the mounting opening 9 and a pad retaining bracket 14 is supported on the pad retaining springs, wherein the brake pads 3 are held in a pre-tensioned manner in the brake carrier 6. Furthermore, a resetting device is arranged in the known disc brake and with which the brake pads 3 can be retrieved after the brake is released, wherein this resetting device is not shown, but can be found in DE 10 2016 117 777 A1.

In FIG. 2, which shows the brake pads 3 in a non-applied position, a partial section of the disc brake shows the rear side of the pad carrier plate 4 that is facing away from a brake disc 2, to which two leaf springs 15, 15′, each having a spring arm 16, 16′, are attached.

The spring arms 16, 16′ project beyond the associated narrow side of the pad carrier plate 4 in the circumferential direction of the brake side 2 and are supported on the associated brake carrier horn 7 of the brake carrier 6.

The leaf spring 15, 15′ is attached in such a manner as to prevent rotation to the side of the brake backing plate 4 that is facing away from the friction lining 5 by an attaching element 17, for example a rivet.

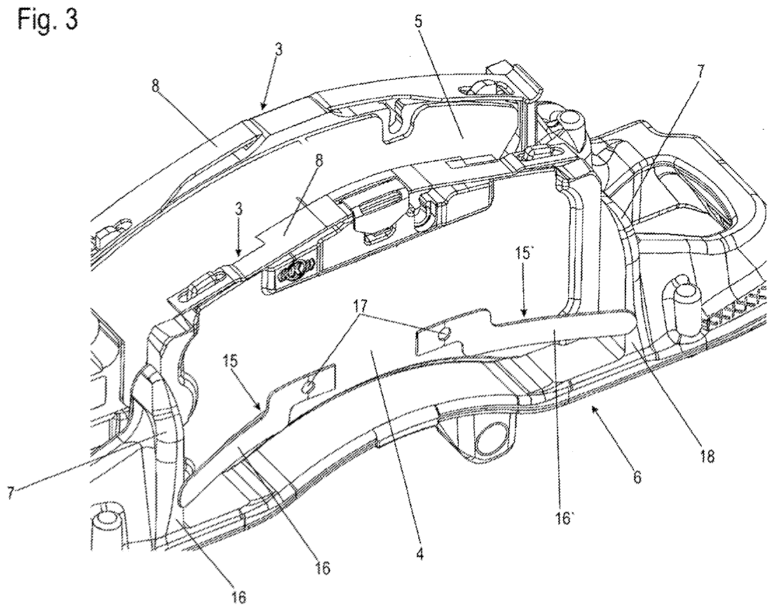

FIG. 3 shows a position of the brake pads 3 in which they are applied, i.e. displaced in a braking function towards a brake disc (not shown). As can be clearly seen, the leaf springs 15, 15′ or the spring arms 16, 16′ are tensioned with contact to the brake carrier horns 7, which serve as abutments, in such a way that the brake pad 3 is pulled back into an initial position when the brakes are released.

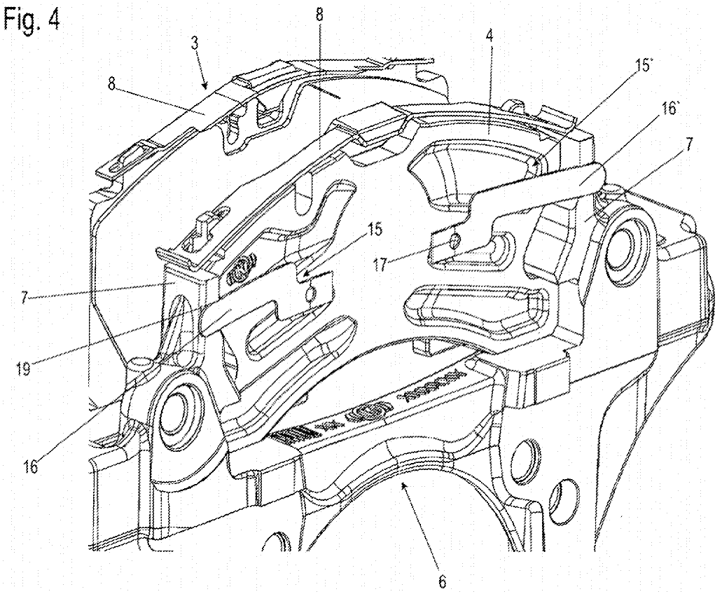

In order to pre-tension the leaf springs 15, 15′, the brake carrier horns 7 each have a bevel 18 that rises from an insertion position of the brake pad 3 to an end position.

Whereas in the example shown in FIGS. 2 and 3, the leaf springs 15, 15′ which are Z-shaped in plan are attached to the area of the brake pad carrier plate 4 that lies opposite the pad retaining spring 8 and the leaf springs lies with their spring arms 16, 16′ approximately in the base area of the associated brake carrier horn 7, in the example shown in FIG. 4 the leaf springs 15, 15′ are arranged in the area of the brake pad carrier plate 4 that face the pad retaining spring 8.

The spring arms 16, 16′ each lie in a recess 19, which is recessed approximately in the head area of the respective brake carrier horn 7, so that the brake pad 3 is held radially secured in the brake carrier 6. Furthermore, in the example shown in FIG. 4, the brake pad 3 assumes the same position displaced in the direction of the brake disc as that shown in FIG. 3.

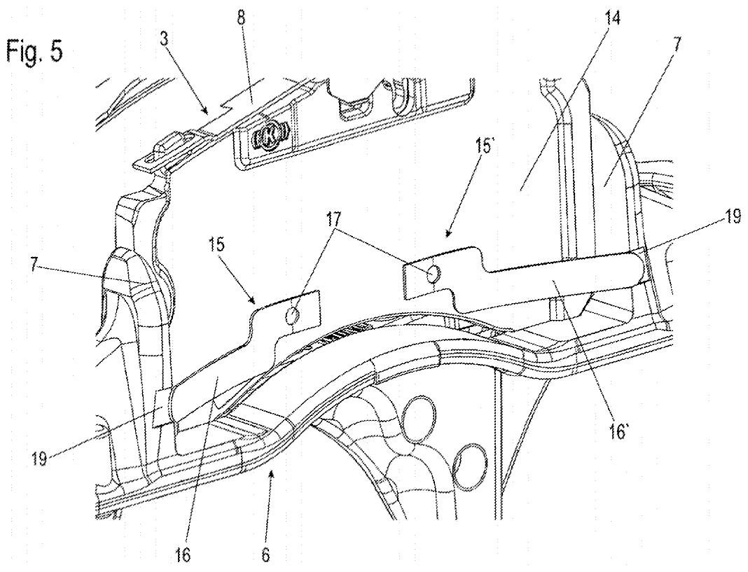

The example shown in FIG. 5 also shows an embodiment variant in which the brake carrier horns 7 are provided with recesses 19, in each of which the associated spring arm 16, 16′ of the leaf springs 15, 15′ is positively engaged in a radial direction. However, in the example shown in FIG. 5, these recesses 19 are provided approximately in the base area of the respective brake carrier horn 7.

### LIST OF REFERENCE SYMBOLS

1 Disc brake
2 Brake disc
3 Brake pad
4 Pad carrier plate
Friction lining
6 Brake carrier
7 Brake carrier horn
8 Pad retaining spring
9 Mounting opening
Brake caliper
11 Brake plunger
12 Caliper back
13 Tension strut
14 Pad retaining bracket
15, 15′ Leaf spring
16, 16′ Spring arm
17 Attaching element
18 Bevel
19 Recess

1.-15. (canceled)

16. A disc brake for a utility vehicle, comprising:
a sliding brake caliper which engages over a brake disc in use;
two brake pads which are arranged in the caliper, moveable in opposite directions in a direction of the brake disc and each have a pad carrier plate and a friction lining attached thereon,
a vehicle-side brake carrier having pad shafts which are delimited in a direction of rotation of the brake disc by brake carrier horns, wherein the brake pads are each arranged in a pad shaft; and
at least one resetting device, by which the brake pads can be returned after a braking-related displacement and release of the disc brake, wherein
the resetting device has at least one resetting element designed as a leaf spring, the leaf spring being attached to a rear side of the pad carrier plate facing away from the friction lining, and having a spring arm that extends in a circumferential direction of the brake disc and is supported on the brake carrier as a fixed component.

17. The disc brake as claimed in claim 16, wherein
a respective spring arm lies against each brake carrier horn.

18. The disc brake as claimed in claim 16, wherein
the spring arm lies in the foot or head region of the brake carrier horn.

19. The disc brake as claimed in claim 16, wherein
the leaf spring is held so as to prevent rotation on the pad carrier plate.

20. The disc brake as claimed in claim 16, wherein
the leaf spring is approximately Z-shaped in plan view.

21. The disc brake as claimed in claim 16, wherein
the spring arm positively engages in a recess of the brake carrier horn in the radial direction.

22. The disc brake as claimed in claim 16, wherein
the brake carrier horn is configured so as to rise at an angle in the direction of insertion of the brake pad.

23. The disc brake as claimed in claim 16, wherein
the leaf spring lies in a pre-tensioned manner against the brake carrier horn.

24. The disc brake as claimed in claim 16, wherein
the leaf springs that are arranged at a distance from one another are different in terms of their spring characteristics.

25. The disc brake as claimed in claim 21, wherein
the recesses are provided in a foot or head region of the brake carrier horn.

26. A brake pad for a disc brake for a utility vehicle, comprising:
a pad carrier plate and a friction lining held thereon, wherein
the pad carrier plate has, in plan view, two opposite-lying longitudinal sides and two opposite-lying narrow sides; and
at least one leaf spring, each leaf spring having a spring arm,
wherein the leaf spring is attached, associated with a narrow side, to the side of the pad carrier plate that faces away from the friction lining, and the spring arm projects beyond its associated narrow side.

27. The brake pad as claimed in claim 26, wherein
the at least one leaf spring is held in a manner so as not to be rotatable on the pad carrier plate.

28. The brake pad as claimed in claim 26, wherein
a pad retaining spring is held on one longitudinal side of the brake pad, and
two leaf springs are arranged on the region of the pad carrier plate that is facing towards or away from the pad retaining spring.

29. The brake pad as claimed in claim 26, wherein
the two leaf springs are Z-shaped in plan.

30. The brake pad as claimed in claim 28, wherein
the opposite-lying leaf springs are arranged symmetrically to the center of the brake pad.
